(19) United States
(12) Patent Application Publication
(10) Pub. No.: US 2005/0275772 A1
(43) Pub. Date: Dec. 15, 2005

(54) Method of producing an electrode substrate, electrode substrate produced by the method, electrostatic actuator provided with the substrate, liquid droplet ejecting head provided with the actuator, and liquid droplet ejecting apparatus provided with the head

(76) Inventors: Kazufumi Oya, Suwa (JP); Tomohiro Makigaki, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/116,057

(22) Filed: Apr. 27, 2005

(30) Foreign Application Priority Data
Jun. 11, 2004 (JP) 2004-174684

(51) Int. Cl. G02F 1/1335; G01P 15/00; G01P 15/125

(52) U.S. Cl. 349/113; 73/514.18; 73/514.32

(57) ABSTRACT

A method of producing an electrode substrate is provided that can form at least one recess of various configurations on an electrode substrate through a simplified process and with an increased degree of precision. Also provided are an electrode substrate produced by the method, an electrostatic actuator provided with the electrode substrate, a liquid droplet ejecting head provided with the actuator and a liquid droplet ejecting apparatus provided with the head. The method comprises a first step of forming at least one recess 41 on a glass substrate 4a through a press forming process in which a pressing mold is pressed against the glass substrate, and a second step of providing an electrode 42 on a bottom surface of each recess 41. The press forming process is preferably carried out under a condition that the substrate is heated up to a temperature of 350 to 800° C. It is desirable that the glass composing the glass substrate 4a has a coefficient of thermal expansion in the range of 20×10⁻⁷ to 90×10⁻⁷° C.⁻¹.

### BACKGROUND OF THE INVENTION

1. Field of the Invention

The present invention relates to a method of producing an electrode substrate employed in an electrostatic actuator. The invention is also directed to an electrode substrate produced by the method, an electrostatic actuator provided with the substrate, a liquid droplet ejecting head provided with the actuator and a liquid droplet ejecting apparatus provided with the head.

2. Description of the Prior Art

As an example of liquid droplet ejecting apparatuses, an ink jet head is known. One example of the ink jet head is disclosed in Japanese Laid-Open Patent Publication No. 2000-355103. The ink jet head includes an ink receiving chamber and a nozzle communicating with the ink receiving chamber. In such an ink jet head, by displacing a portion of the wall of the ink receiving chamber and thereby changing the volume of the ink receiving chamber, ink droplets can be ejected from the nozzle.

The ink jet head disclosed in this Japanese laid-open patent publication is provided with an electrostatic actuator for displacing a portion of the wall of the ink receiving chamber, in which a portion of the wall of the ink receiving chamber serves as a vibrator plate. The electrostatic actuator is adapted to apply electric voltage between the vibrator plate and an electrode facing the vibrator plate with a small gap therebetween, so that an electrostatic force is generated between the vibrator plate and the electrode to thereby cause the vibrator plate to vibrate. The electrode is disposed on an electrode substrate. Typically, the electrode is disposed on the bottom surface of a recess formed in the electrode substrate in order to create the small gap referred to above.

In the Japanese laid-open patent publication cited above, for the sake of reducing drive voltage, the bottom surface of the recess has such a configuration that the gap between the vibrator plate and the electrode is changed stepwise or continuously.

An etching technique has been utilized in forming the recess on a glass substrate. Particularly, according to the afore-mentioned Japanese laid-open patent publication, two methods are employed to make the bottom surface of the recess in such a shape that the gap between the vibrator plate and the electrode is changed stepwise or continuously. One method is to use a photo mask (transmitted light scattering mask) having a light transmitting region where the transmitted light is scattered. The other method is to use a photo mask (gray scale mask) with a multiplicity of apertures to change the aperture rate and hence the light transmittance.

In the event that the bottom surface of the recess is processed through the use of the transmitted light scattering mask, however, a difficulty is encountered in controlling the light scattering on the photo mask, thus making it difficult to form the recess into a desired shape.

On the other hand, if the bottom surface of the recess is processed through the use of the gray scale mask, there exist a difficulty in continuously controlling the change of the light transmittance of the photo mask, which results in a problem in that ripple-shaped irregularities with the same pitch as the apertures are formed on the bottom surface of the recess of the electrode substrate.

As described above, the methods disclosed in the cited Japanese laid-open patent publication have a difficulty in forming the recess into a desired shape and with an increased degree of precision. This leads to the failure to precisely control the gap between the electrode and the vibrator plate.

### SUMMARY OF THE INVENTION

It is therefore an object of the present invention to provide a method of producing an electrode substrate that can form a recess of various configurations on an electrode substrate through a simplified process and with an increased degree of precision.

Another object of the present invention is to provide an electrode substrate produced by the method, an electrostatic actuator provided with the substrate, a liquid droplet ejecting head provided with the actuator and a liquid droplet ejecting apparatus provided with the head.

In order to achieve these objects, the present invention is directed to a method of producing an electrode substrate, which comprises a first step of forming at least one recess on a substrate mainly composed of glass through a press forming process in which a pressing mold is pressed against the substrate and a second step of providing an electrode on a bottom surface of the recess.

According to the method described above, it becomes possible to form a recess of various configurations on an electrode substrate through a simplified process and with an increased degree of precision. As a result, an electrostatic actuator incorporating the electrode substrate thus obtained has an ability to precisely control the gap between an electrode and a vibrator plate.

In the method of producing an electrode substrate according to the present invention, it is preferred that the press forming process is carried out under a condition that the substrate is heated up to a temperature of 350 to 800° C.

This makes it possible to form a recess of various configurations on an electrode substrate with an increased degree of precision, while preventing any deformation or deterioration of the substrate.

In the method of producing an electrode substrate according to the present invention, it is preferred that the glass has a coefficient of thermal expansion in the range of 20×10^{-7 to} 90×10⁻⁷° C.⁻¹.

This makes it possible to suppress the stress generated in the substrate to a reduced level and prevent any damage of the substrate, which may otherwise be unavoidable in the process of bonding the electrode substrate obtained with a silicon substrate.

In the method of producing an electrode substrate according to the present invention, it is also preferred that the glass is mainly composed of borosilicate glass.

This also makes it possible suppress the stress generated in the substrate to a smaller level, which may otherwise be unavoidable in the process of bonding the electrode substrate obtained with a silicon substrate.

In the method of producing an electrode substrate according to the present invention, it is also preferred that the pressing mold is mainly composed of quartz.

This assures that a recess is formed on the electrode substrate with an increased reproducibility, while keeping the durability of the pressing mold.

In the method of producing an electrode substrate according to the present invention, it is preferred that the pressing mold is subjected to mold release treatment at least on a pressure-applying contact surface of the pressing mold that makes contact with the substrate.

This makes it easy to take out the substrate mainly composed of glass from the pressing mold.

In the method of producing an electrode substrate according to the present invention, it is also preferred that the mold release treatment is carried out by applying a release agent to the pressure-applying contact surface.

By way of this, it becomes possible to perform the mold release treatment to the pressing mold in a simpler and easier manner.

In the method of producing an electrode substrate according to the present invention, it is preferred that the mold release treatment is carried out by forming a film on the pressure-applying contact surface, in which the film is mainly composed of a material selected from the group consisting of platinum-containing alloy and iridium-containing alloy.

This makes it easy to take out the substrate mainly composed of glass from the pressing mold.

In the method of producing an electrode substrate according to the present invention, it is also preferred that the film is formed on the pressure-applying contact surface under a condition that a base layer for assuring close contact of the film with the pressing mold is provided between the film and the pressure-applying contact surface.

This assures close contact of the pressing mold with the film and prevents the film from peeling off from the pressing mold when the substrate mainly composed of glass is taken out of the pressing mold.

In the method of producing an electrode substrate according to the present invention, it is also preferred that the base layer is mainly composed of nickel.

This assures that the pressing mold makes close contact with the film.

In the method of producing an electrode substrate according to the present invention, it is also preferred that the film is formed after the pressure-applying contact surface is subjected to surface roughening process.

This assures close contact of the pressing mold with the film and prevents the film from peeling off from the pressing mold when the substrate mainly composed of glass is taken out of the pressing mold.

In the method of producing an electrode substrate according to the present invention, it is also preferred that the surface roughening process includes reverse sputtering.

By means of the reverse sputtering, the external surface of the pressing mold is activated to thereby assure improved close contact of the pressing mold with the film.

In the method of producing an electrode substrate according to the present invention, it is also preferred that the recess is provided with portions of different depth.

By virtue of this, if the resultant electrode substrate is incorporated in an electrostatic actuator, stable forces can be generated with reduced drive voltage. In addition, the liquid droplet ejecting characteristic of a liquid droplet ejecting head becomes excellent in the event that such an electrostatic actuator is incorporated in the liquid droplet ejecting head.

In the method of producing an electrode substrate according to the present invention, it is also preferred that the recess extends substantially linearly and has at least a portion whose depth is gradually reduced in a continuous or stepwise manner from one side to the other in a longitudinal direction of the recess.

This makes sure that, when the resultant electrode substrate is incorporated in an electrostatic actuator, stable forces are generated with reduced drive voltage.

Another aspect of the present invention is directed to an electrode substrate produced by the method described above.

If such an electrode substrate is incorporated in an electrostatic actuator, stable forces can be generated with reduced drive voltage. In addition, the liquid- droplet ejecting characteristic of a liquid droplet ejecting head becomes excellent in the event that such an electrostatic actuator is incorporated in the liquid droplet ejecting head.

Yet another aspect of the present invention is directed to an electrode substrate which comprises a substrate mainly composed of glass and having at least one recess formed through a press forming process in which a pressing mold is pressed against the substrate, and an electrode provided on a bottom surface of the recess of the substrate.

If such an electrode substrate is incorporated in an electrostatic actuator, stable forces can be generated with reduced drive voltage. In addition, the liquid droplet ejecting characteristic of a liquid droplet ejecting head becomes excellent in the event that such an electrostatic actuator is incorporated in the liquid droplet ejecting head.

In the electrode substrate according to the present invention, it is preferred that the electrode is formed substantially simultaneously with the recess by the press forming of a constituent material of the substrate under a condition that a constituent material of the electrode is disposed between the constituent material of the substrate and the pressing mold.

Incorporation of this electrode substrate into an electrostatic actuator makes it possible to precisely control the distance (gap length) between the vibrator plate and the electrode with the degree of precision as high as the pressing mold, which means that electrostatic forces can be generated in a more stable manner.

The other aspect of the present invention is directed to an electrostatic actuator which comprises an electrode substrate described above and a vibrator plate adapted to face an electrode of the electrode substrate with a minute gap between the vibrator and the electrode, wherein the vibrator plate is displaceable by an electrostatic force induced when electric voltage is applied between the electrode and the vibrator plate.

This electrostatic actuator can generate stable forces with reduced drive voltage. In addition, the liquid droplet ejecting characteristic of a liquid droplet ejecting head becomes excellent if such an electrostatic actuator is incorporated in the liquid droplet ejecting head.

Other aspect of the present invention is directed to a liquid droplet ejecting head equipped with the electrostatic actuator described above.

By virtue of this, stable forces can be generated with reduced drive voltage, as a result of which the liquid droplet ejecting characteristic exhibited by the liquid droplet ejecting head becomes excellent.

Yet other aspect of the present invention is directed to a liquid droplet ejecting apparatus equipped with the liquid droplet ejecting head described above.

This assures that stable forces can be generated with reduced drive voltage, as a result of which the liquid droplet ejecting characteristic exhibited by the liquid droplet ejecting head becomes excellent.

The above and other objects and features of the invention will become more apparent from the following detailed description when the same is read in conjunction with the accompanying drawings that are presented for the purpose of illustration only.

### BRIEF DESCRIPTION OF THE DRAWINGS

FIG. 1 is a top view showing an ink jet head whose electrode substrate was produced in accordance with a first embodiment of the present invention.

FIG. 2 is a cross-sectional view of the ink jet head taken along line A-A in FIG. 1.

FIG. 3 is a cross-sectional view of the ink jet head taken along line B-B in FIG. 1.

FIG. 4(A) to (F) is a cross-sectional view illustrating a method of manufacturing the ink jet head shown in FIG. 1.

FIG. 5(A) to (E) is a cross-sectional view illustrating a method of manufacturing the ink jet head shown in FIG. 1.

FIG. 6(A) to (D) is a cross-sectional view illustrating a method of manufacturing the ink jet head shown in FIG. 1.

FIG. 7(A) to (C) is a cross-sectional view illustrating a method of manufacturing the ink jet head shown in FIG. 1.

FIG. 8(A) to (D) is a cross-sectional view illustrating a method of manufacturing the ink jet head shown in FIG. 1.

FIG. 9 is a cross-sectional view showing a press forming apparatus.

FIG. 10 is a top view of the press forming apparatus depicted in FIG. 9.

FIG. 11 is a cross-sectional view showing a pressing mold that the press forming apparatus depicted in FIG. 9 is provided with.

FIG. 12 is a cross-sectional view showing a surface treatment tool.

FIG. 13 is a cross-sectional view showing an ink jet head whose electrode substrate was produced in accordance with a second embodiment of the present invention.

FIG. 14 is a cross-sectional view showing another example of the pressing mold that the press forming apparatus is provided with.

FIG. 15 is a cross-sectional view showing an ink jet head whose electrode substrate was produced in accordance with a third embodiment of the present invention.

FIG. 16 is a cross-sectional view showing a further example of the pressing mold that the press forming apparatus is provided with.

FIG. 17 is a cross-sectional view showing an ink jet head whose electrode substrate was produced in accordance with a fourth embodiment of the present invention.

FIG. 18 is a cross-sectional view showing a still further example of the pressing mold that the press forming apparatus is provided with.

### DETAILED DESCRIPTION OF THE PREFERRED EMBODIMENTS

Hereinafter, preferred embodiments of the present invention will be described in detail with reference to the appended drawings.

### First Embodiment

At first, a description will be made with regard to a method of producing an electrode substrate in accordance with a first embodiment of the present invention. In advance of describing the method, however, for better understanding, a description will be first made with regard to an ink jet head that includes an electrode substrate produced by the method of the present invention.

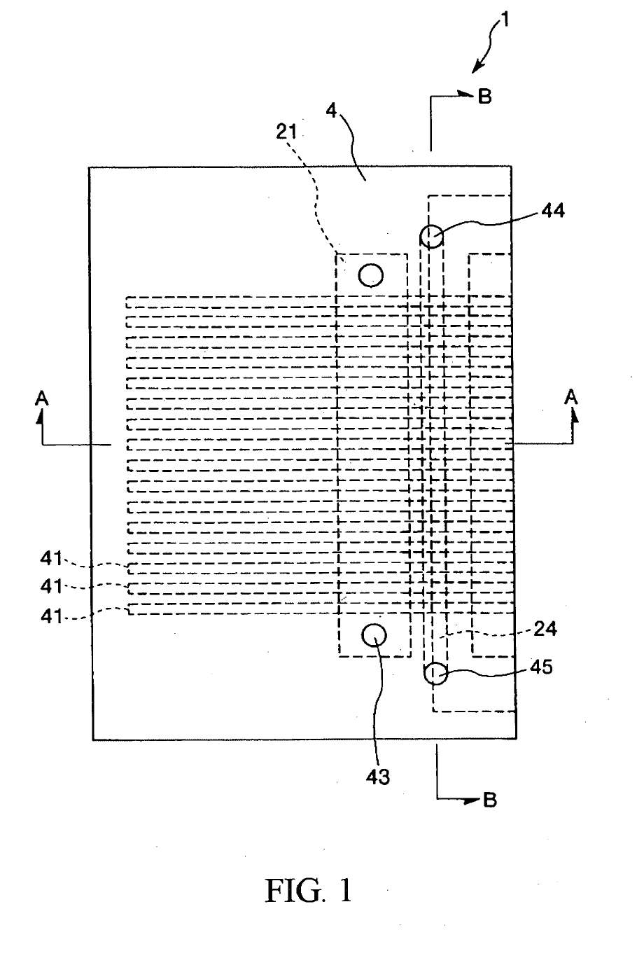

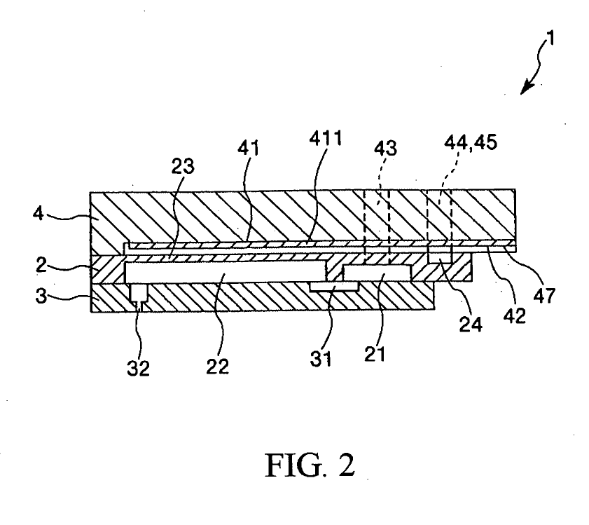

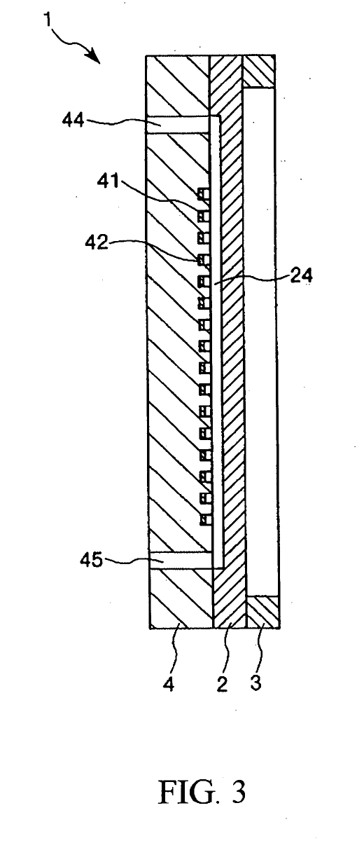

FIG. 1 is a top view showing an ink jet head whose electrode substrate was produced in accordance with a first embodiment of the present invention, FIG. 2 is a cross-sectional view of the ink jet head taken along line A-A in FIG. 1, and FIG. 3 is a cross-sectional view of the ink jet head taken along line B-B in FIG. 1. It should be understood that “top” or “upper” in the following description indicates the upward direction or the top area, “bottom” or “lower” indicates the downward direction or the bottom area, “front” or “frontward” indicates the left side, and “rear” or “rearward” indicates the right side, as viewed in FIG. 2.

The ink jet head 1 shown in FIGS. 1 to 3 has a cavity substrate 2, a nozzle substrate 3 bonded to the bottom surface thereof and an electrode substrate 4 bonded to the top surface thereof. In other words, the ink jet head 1 takes a three layer arrangement wherein the nozzle substrate 3, the cavity substrate 2 and the electrode substrate 4 are arranged (laminated) in this order from the bottom to the top.

The cavity substrate 2 is formed with grooves that define a common ink chamber 21 and a plurality of ink ejecting chambers 22 between the cavity substrate 2 and the nozzle substrate 3. The nozzle substrate 3 is formed with a plurality of grooves that define ink orifices 31 between the nozzle substrate 3 and the cavity substrate 2, in which each ink orifice 31 serves to bring the common ink chamber 21 into communication with each of the plurality of ink ejecting chambers 22. More specifically, between the cavity substrate 2 and the nozzle substrate 3, there are provided the common ink chamber 21, the ink orifices 31 and the plurality of ink ejecting chambers 22. Each of the cavity substrate 2 and the nozzle substrate 3 is mainly composed of e.g., silicon.

The nozzle substrate 3 is provided with a nozzle hole 32 at a location corresponding to the front end part of each of the ink ejecting chambers 22, in which the nozzle hole 32 is in communication with the corresponding ink ejecting chamber 22.

The top wall portion of the cavity substrate 2 located just above the respective ink ejecting chamber 22 has a reduced thickness, and it serves as a vibrator plate 23 that can be elastically displaced in a direction perpendicular to the surface of the wall portion, namely, in the up-and-down direction in FIG. 2.

In the meantime, the electrode substrate 4 is mainly composed of glass. On the surface of the electrode substarate 4 bonded to the cavity substrate 2, there are formed a plurality of recesses 41 at positions corresponding to the respective vibrator plates 23.

On the bottom surface 411 of each of the recesses 41, there is formed an individual electrode 42 made of indium tin oxide (ITO) and the like. The individual electrodes 42 in the recesses 41 respectively face the corresponding vibrator plates 23 with a minute gap therebetween, in which the vibrator plates 23 function as a common electrode for the individual electrodes 42. In addition, each of the individual electrodes 42 extends up to the rear end of the electrode substrate 4, the rear end part of which functions as an electrode tail extension 47 to which an external wire is connected. Electrically connected to the electrode tail extension 47 is a voltage applying means (not shown) that can apply electric voltage between the individual electrode 42 and the vibrator plate 23.

Further, the cavity substrate 2 is formed with a sealant injection groove 24 on its surface bonded to electrode substrate 4. The sealant injection groove 24 is formed at a position more rearwards than the common ink chamber 21 and extends in a direction orthogonal to the respective recess 41. Further, the sealant injection groove 24 is in communication with each of the recesses 41 at the intersecting point where the sealant injection groove 24 meets with the respective recesses 41.

At the positions corresponding to the opposite ends of the sealant injection groove 24, the electrode substrate 4 is formed with a sealant introduction hole 44 and a sealant discharge hole 45, both of which penetrate the electrode substrate 4 in the thickness direction thereof and communicate with the sealant injection groove 24.

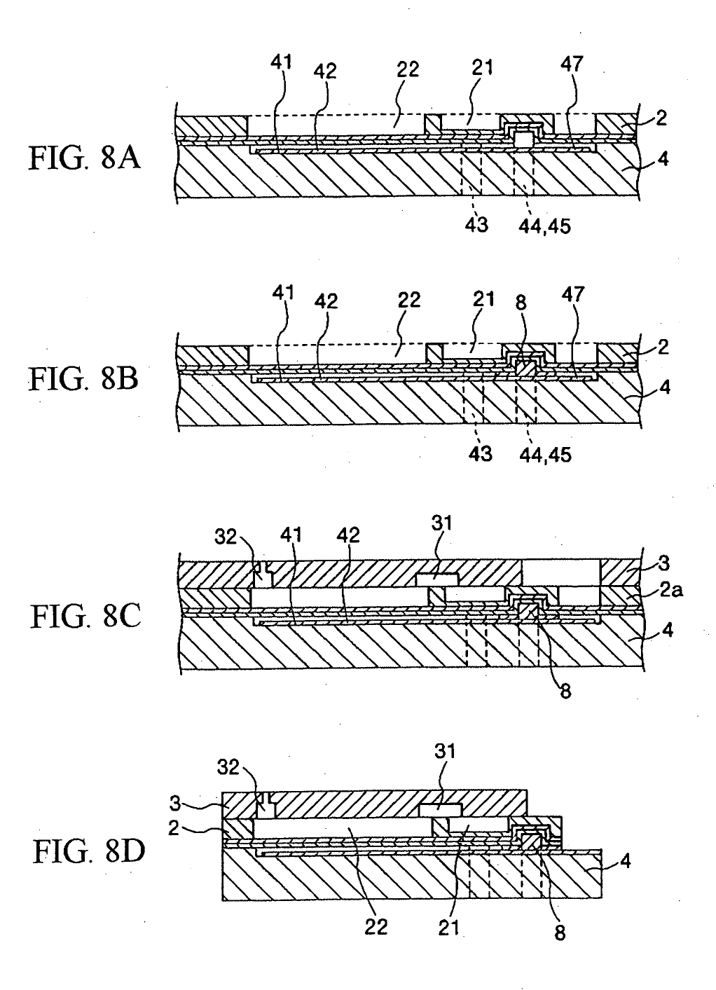

The sealant injection groove 24, the sealant introduction hole 44 and the sealant discharge hole 45 are adapted to form a sealant flow path at the time of filling a sealant into the recesses 41. Specifically, the sealant 8, which is shown only in FIG. 8 (B), (C) and (D), is injected through the sealant introduction hole 44 and then flows along the sealant injection groove 24 from one end to the other end thereof. A part of the sealant 8 flowing through the sealant injection groove 24 is pulled toward and filled into the portion of each of the recesses 41 adjacent to the sealant injection groove 24, by what is called a capillary phenomenon. Injection of the sealant 8 is ceased when the sealant 8 reaches the other end of the sealant injection groove 24 and enters into the sealant discharge hole 45. By this process, the gap between each of the vibrator plates 23 and each of the individual electrodes 42 is closed.

Furthermore, the electrode substrate 4 is provided with an ink supply hole 43 which is in communication with the common ink chamber 21. Ink is supplied from an external ink tank (not shown in the drawings) to the common ink chamber 21 through the ink supply hole 43. The ink arrived at the common ink chamber 21 is fed to each of the ink ejecting chambers 22 via the ink orifice 31.

With the ink jet head 1 described above, the vibrator plate 23, the individual electrode 42 and the voltage applying means (not shown) cooperatively constitute an electrostatic actuator. To be more specific, if the voltage applying means applies drive voltage between the vibrator plate 23 and the individual electrode 42, an electrostatic force is generated therebetween. This causes the vibrator plate 23 to be flexed and displaced toward the individual electrode 42, thus increasing the volume of the ink ejecting chamber 22. Subsequently, if the drive voltage is removed, the vibrator plate 23 is restored by its elastic restoring force, which abruptly reduces the volume of the ink ejecting chamber 22. By the ink pressure induced at this moment, a part of the ink filled in the ink ejecting chamber 22 is ejected as an ink droplet from the nozzle hole 32 that communicates with the ink ejecting chamber 22.

Next, an example of the method of manufacturing an ink jet head that employs the electrode substrate production method according to the present invention will be described, in which the ink jet head shown in FIG. 1 is produced for example.

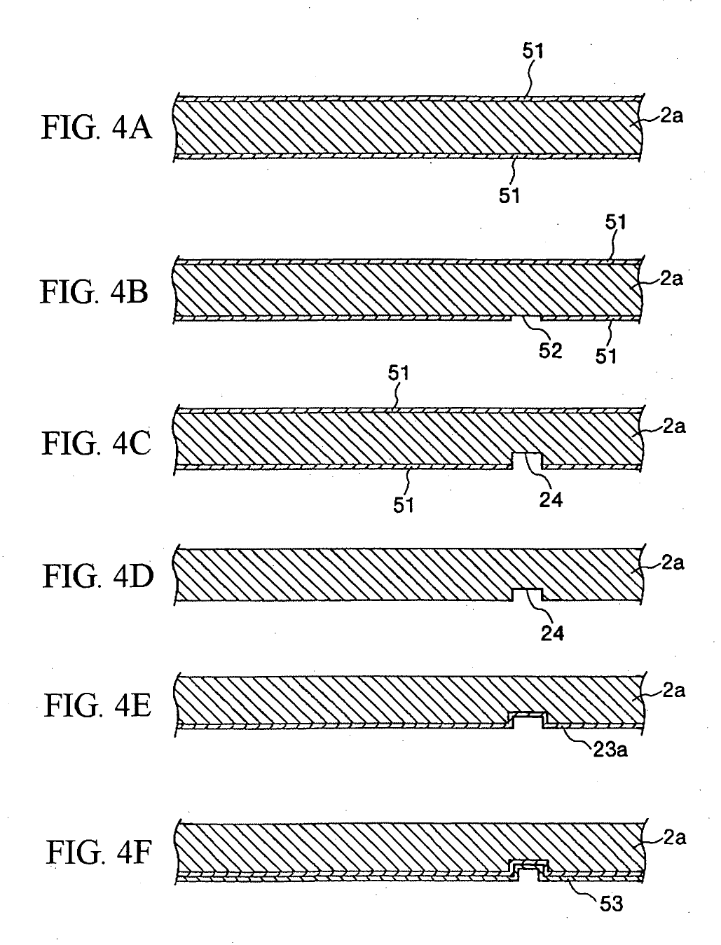

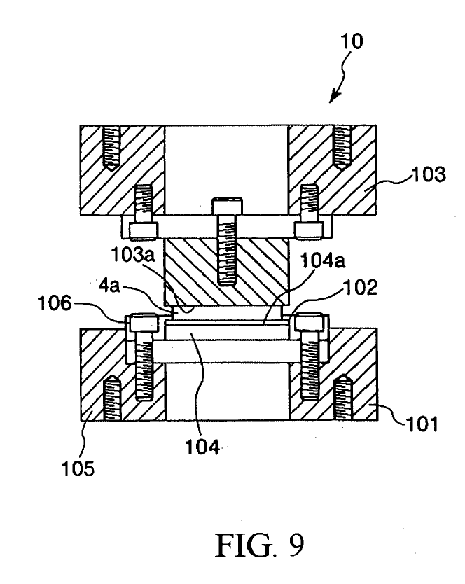

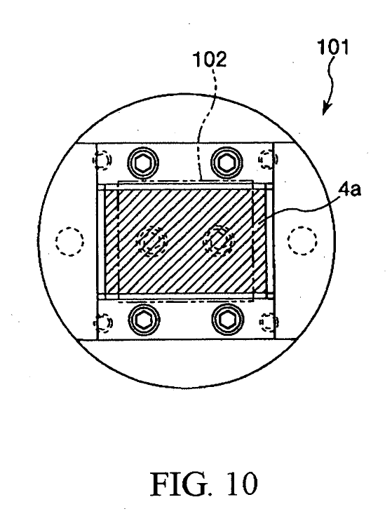

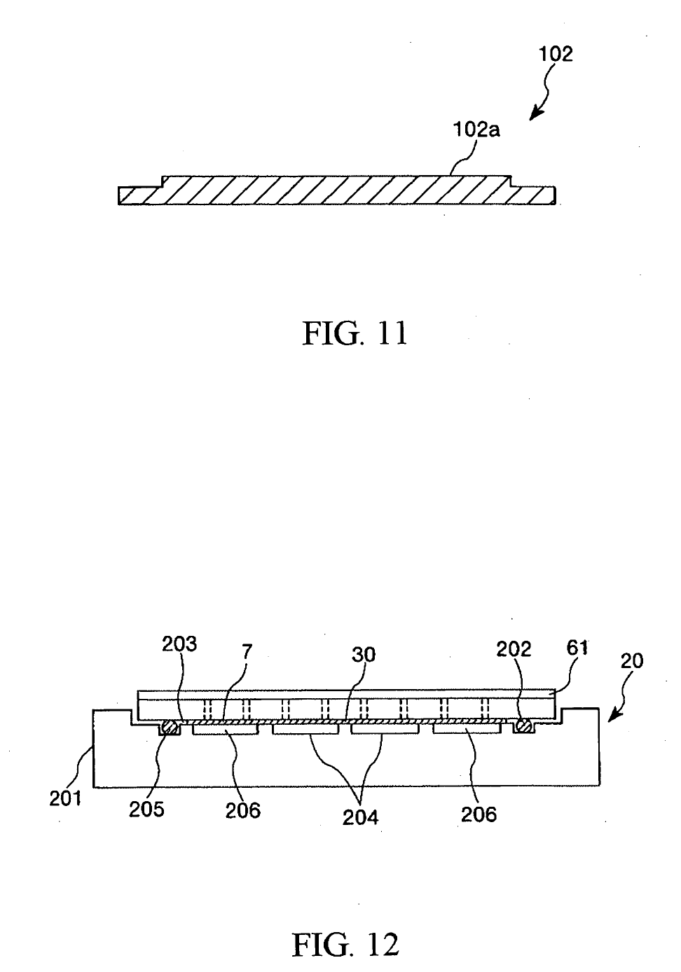

FIG. 4 to FIG. 8 are schematic cross-sectional views illustrating the steps of manufacturing an ink jet head 1; FIG. 9 is a cross-sectional view showing a press forming apparatus; FIG. 10 is a top view showing the bottom mold that the press forming apparatus depicted in FIG. 9 is provided with; FIG. 11 is a cross-sectional view showing a pressing mold that the press forming apparatus depicted in FIG. 9 is provided with; and FIG. 12 is a cross-sectional view showing a surface treatment tool. It should be understood that “top” or “upper” in the following description indicates the upward direction or the top area, “bottom” or “lower” indicates the downward direction or the bottom area, “front” or “frontward” indicates the left side, and “rear” or “rearward” indicates the right side, as viewed in FIG. 4 to FIG. 8.

The method of manufacturing the ink jet head 1 comprises a step of forming a sealant injection groove, an impurity diffusion layer and an insulating film, a step of producing an electrode substrate, a step of bonding a silicon substrate and an electrode substrate together, a step of forming a common ink chamber and an ink ejecting chamber, and a step of bonding a nozzle substrate to the substrates bonded earlier. These steps will now be described one by one.

[1] Step of Forming a Sealant Injection Groove, an Impurity Diffusion Layer and an Insulating Film

(1-1) At first, a silicon substrate 2a is prepared whose lower surface has been subjected to grinding. The thickness of the silicon substrate 2a is preferably, but not particularly limited thereto, 100 to 1,000 μm and more preferably 200 to 600 μm

The silicon substrate 2a is then subjected to thermal oxidization treatment as illustrated in FIG. 4(a) to form an oxide film (SiO₂ film) 51 thereon.

Examples of the thermal oxidization treatment include, but are not particularly limited thereto, steam oxidization, wet oxidization, dry oxidization, high pressure oxidization and diluted oxygen oxidization, which may be used independently or in combination. In case of the steam oxidization, for instance, oxidization is carried out in the atmosphere of steam-containing oxygen. The thickness of the oxide film 51 is preferably, but not particularly limited thereto, 0.1 to 5 μm and more preferably 0.5 to 2 μm.

(1-2) Next, on the oxide film 51 of the silicon substrate 2a, a photoresist is formed, by photolithography, that has an opening in the area corresponding to the sealant injection groove 24. The oxide film 51 is etched by using the photoresist as a mask and then the photoresist is removed. This creates an opening 52 in the area of the oxide film 51 that corresponds to a sealant injection groove 24, as illustrated in FIG. 4(B).

Subsequently, the silicon substrate 2a is etched by using the oxide film 51 as a mask, as a result of which a sealant injection groove 24 is formed as illustrated in FIG. 4(C).

Examples of the etching solution that can be used in this process include aqueous potassium hydroxide solution, aqueous sodium hydroxide solution and aqueous tetramethylammonium hydroxide (TMAH) solution, and the like. In case of using aqueous potassium hydroxide solution, for instance, it is preferred that the concentration of potassium hydroxide is in the range of 10 to 50 wt % with the etching temperature of 60 to 120° C.

At the end of etching process, the oxide film 51 formed on the surface of the silicon substrate 2a is removed through the use of aqueous fluoric acid solution, etc., as illustrated in FIG. 4(D).

(1-3) In the next step, impurity is doped on the lower surface of the silicon substrate 2a to form an impurity diffusion layer 23a, as illustrated in FIG. 4(E). The impurity diffusion layer 23a is adapted to compose the vibrator plate 23 in the ink jet head obtained. Moreover, the impurity diffusion layer 23a has different etching speed than the silicon substrate 2a with respect to the same etching solution and therefore plays the role of an etching stopper layer in the subsequent etching process of the silicon substrate 2a. This means that the vibrator plate 23 having a desired thickness can be obtained by way of controlling the thickness of the impurity diffusion layer 23a. In addition, the impurity diffusion layer 23a has lower electric resistance than the silicon substrate 2a, thus assuring that the part of the impurity diffusion layer 23a which will be used as the vibrator plate 23 exhibits such an excellent electric conductivity as to be as a common electrode.

Examples of the impurity include boron and the like. It is preferred that the doping amount of the impurity is in the range of 5×10⁻¹⁹ to 12×10⁻¹⁹ atom/cc. If the doping amount is less than the lower limit, it may be difficult, when the silicon substrate 2a is etched, to positively stop the etching procedure at the very point where the impurity diffusion layer 23a is exposed, depending on the etching conditions employed. Furthermore, there exists a possibility that the conductivity obtained may be insufficient for the common electrode.

(1-4) An insulating film 53 is then formed on the impurity diffusion layer 23a, as illustrated in FIG. 4(F).

Examples of the insulating film 53 include an oxide based insulating film such as SiO₂, a nitride based insulating film such as Si₃N₄, and the like.

Examples of the method of forming the insulating film 53 include chemical vapor deposition (CVD) such as plasma CVD, thermal CVD and laser CVD, and dry plating such as sputtering, and the like.

[2] Step of Producing an Electrode Substrate

(2-1) An electrode substrate 4 is produced in the second place.

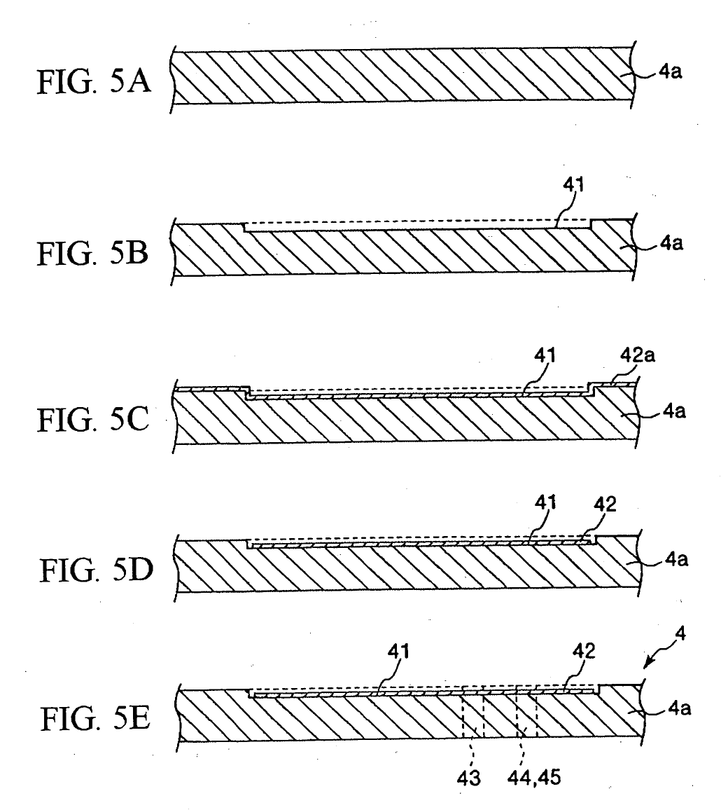

As shown in FIG. 5(A), a glass substrate 4a that is mainly composed of glass is first prepared.

It is preferred to use, as the glass substrate 4a, a substrate whose thermal expansion coefficient shows no great difference from that of the cavity substrate 2. More specifically, the glass composing the glass substrate 4a has a coefficient of thermal expansion preferably in the range of 20×10⁻⁷ to 90×10⁻⁷° C.⁻¹, more preferably in the range of 35×10⁻⁷ to 45×10⁻⁷° C.⁻¹. This makes it possible to suppress stress that may otherwise be generated in the cavity substrate 2 and the electrode substrate 4 when they are bonded together, thereby preventing any breakage of the substrates. In case of using the silicon substrate 2a as the cavity substrate 2, for instance, it is preferred that a substrate mainly composed of borosilicate glass is employed as the glass substrate 4a. This is because the glass substrate material has a thermal expansion coefficient similar to that of silicon.

It is also preferred that the thickness of the glass substrate 4a is in the range of 0.5 to 1.5 mm.

(2-2) Subsequently, a recess 41 is formed on the glass substrate 4a by a press forming process. This press forming process is performed in such a manner that the glass substrate 4a is heated and pressed against a pressing mold that has a depression-and-protrusion corresponding to the recess 41 to be formed on the glass substrate 4a. A press forming apparatus 10 shown in FIG. 9 and FIG. 10, for instance, is used to conduct the press forming process.

The press forming apparatus 10 comprises a bottom mold 101, a pressing mold 102 affixed to the bottom mold 101 and a top mold 103.

The bottom mold 101 is provided with a cylindrical body 104 having a top press surface 104a and a hollow die 105 surrounding the circumference of the cylindrical body 104. The hollow die 105 is adapted to move relative to the cylindrical body 104. Also provided on the cylindrical body 104 are a heating means and a cooling means that serve to properly heat up or cool down the glass substrate 4a placed on the pressing mold 102.

The pressing mold 102 is mounted on the press surface 104a of the cylindrical body 104 and fixedly secured to the cylindrical body 104 by means of a fastener 106 attached to the body 104.

This pressing mold 102 is of plate configuration, one surface of which abuts to the press surface 104a and the other surface of which has a depression-and-protrusion 102a complementary to the shape of the recess 41 to be formed on the glass substrate 4a, as illustrated in FIG. 11. In other words, the depression-and-protrusion 102a of the pressing mold 102 takes an inverse pattern of the recess 41.

Examples of the material from which the pressing mold 102 is made include, but are not particularly limited thereto, quartz, silicon, ceramic, carbon and the like, among which quartz is preferred to use. Use of these material assists in enhancing the transferability of the mold shape and endowing the pressing mold 102 with an increased durability and hence a long term reusability.

Additionally, it is preferred that mold release treatment is conducted at least to the surface of the pressing mold 102 (a pressure-applying contact surface) on which the depression-and-protrusion 102a exists. This makes it possible to remove the glass substrate 4a from the pressing mold 102 with ease.

The mold release treatment can be carried out by way of applying a releasing agent at least to the depression-and-protrusion 102a (that is, the pressure-applying contact surface) of the pressing mold 102. Examples of the releasing agent include rhodium(Rh), palladium(Pd), silver(Ag), iridium(Ir), platinum(Pt), gold(Au) and an alloy containing at least one of these elements. It is preferred that, in the mold release treatment, a thin film composed of a member selected from the group consisting of platinum-containing alloy and iridium-containing alloy is formed at least on the depression-and-protrusion 102a or the pressure-applying contact surface of the pressing mold 102. This makes it possible to readily remove the glass substrate 4a from the pressing mold 102.

In this case, it is preferred that the thin film is formed at least on the depression-and-protrusion 102a (that is, the pressure-applying contact surface) of the pressing mold 102 under a condition that a base layer for assuring close contact of the thin film with the pressing mold 102 is disposed therebetween. This assures close contact of the pressing mold 102 with the thin film and prevents the thin film from peeling off from the pressing mold 102 when the glass substrate 4a is taken out of the pressing mold. 102.

No particular limitation exists in selecting the material for the base layer as far as the material assures the close contact of the pressing mold 102 with the thin film. Examples of the base layer material include the one mainly composed of such metal as nickel(Ni), chromium(Cr) and cobalt(Co), among which nickel-based material is preferred to use.

It is also preferred that the mold release treatment is carried out after the depression-and-protrusion 102a (the pressure-applying contact surface) of the pressing mold 102 was first subjected to surface roughening process. Examples of the surface roughening process include, but are not particularly limited thereto, sand blasting treatment, shot blasting treatment, acid or alkali surface treatment and reverse sputtering treatment, among which the reverse sputtering treatment is preferred to use. If the external surface (the depression-and-protrusion 102a) of the pressing mold 102 becomes roughened by the reverse sputtering in this manner, the pressing mold 102 can make more close contact with the thin film set forth supra.

More specifically, in the event that a base layer mainly composed of nickel is formed on the quartz-made pressing mold 102 and then a thin film primarily composed of platinum-iridium alloy, for instance, it is preferred that surface roughening is first carried out by the reverse sputtering at least for the area that the releasing agent will be applied to, after which the base layer and the thin film are formed in the named sequence. This enhances close contact of the pressing mold 102 with the base layer and/or the thin film and prevents the base layer and/or the thin film from peeling off from the pressing mold 102 at the time when the glass substrate 4a is taken out of the pressing mold 102.

In the meantime, the top mold 103 has a press surface 103a that confronts the press surface 104a of the bottom mold 101. This top mold 103 is suspended from the drive shaft of a pneumatic cylinder (not shown in the drawings) and is adapted to move toward or away from the bottom mold 101.

(2-3) In order to press form the glass substrate 4a with the use of the press forming apparatus 10, the glass substrate 4a is placed on the pressing mold 102 and then softened by heating the same.

The heating temperature is preferably above the crystallization temperature of the glass substrate 4a, more preferably 350 to 800° C. and most preferably 550 to 700° C. If the heating temperature is less than the lower limit, the glass substrate 4a may not be sufficiently softened depending on the kind of material of the glass substrate 4a, thereby leading to insufficient transfer of the depression-and-protrusion 102a of the pressing mold 102 to the glass substrate 4a. If the heating temperature exceeds the upper limit, there exists a possibility that the respective part of the press forming apparatus 10 including the pressing mold 102 and the like is damaged depending on the press conditions of the press forming apparatus 10.

In the next step, the top mold 103 is caused to move down toward the bottom mold 101 so that the press surface 103a of the top mold 103 can be brought into contact with the glass substrate 4a and can apply pressure thereto. This causes the glass substrate 4a to be pressed against the pressing mold 102 in such a manner that the depression-and-protrusion 102a of the pressing mold 102 can be transferred to the glass substrate 4a.

The load that exerts in this pressing operation is preferably 10 to 50 kg/cm² and more preferably 20 to 30 kg/cm². If the load is less than the lower limit, the depression-and-protrusion 102a of the pressing mold 102 may not be sufficiently transferred to the glass substrate 4a, depending on the kind of material of the glass substrate 4a or the pressing mold 102, the heating temperature and other conditions. If the load exceeds the upper limit, it becomes difficult to make the glass substrate 4a with an appropriate thickness, depending on the kind of material of the glass substrate 4a or the pressing mold 102 and other conditions.

Subsequently, the glass substrate 4a is allowed to cool down while the glass substrate 4a remains pressed by the top mold 103. As a result, the glass substrate 4a is solidified with the depression-and-protrusion 102a transferred thereto. The glass substrate 4a thus obtained has a recess 41 formed as an inverse pattern of the depression-and-protrusion 102a, as illustrated in FIG. 5(B).

(2-4) In the ensuing process, an individual electrode 42 is formed on the bottom surface of the recess 41 that has been formed in the above-identified manner.

At first, as shown in FIG. 5(C), a conductive film 42a is formed on the surface of the glass substrate 4a on which the recess 41 lies.

There is no particular limitation in selecting the material for the conductive film 42a as far as the material can be deposited on the glass substrate 4a and can serve as an electrode. Examples of the material for composing the conductive film 42a include: such metallic substances as palladium (Pd), platinum (Pt), gold (Au), tungsten (W), tantalum (Ta), molybdenum (Mo), aluminum (Al), chromium (Cr), titanium (Ti), copper (Cu) and an alloy containing these elements; and, such conductive oxides as ITO, FTO, ATO and SnO₂. One or more of these materials may be used either independently or in combination.

Examples of the conductive film forming method include: chemical vapor deposition (CVD) such as plasma CVD, thermal CVD and laser CVD; vacuum vapor deposition; sputtering (low temperature sputtering); dry plating such as ion plating; wet plating such as electrolytic plating, immersion plating (dip plating) and electroless plating; thermal spray; sol-gel method; metal organic deposition (MOD); and metal foil bonding.

In the foregoing, it should be noted that the thickness of the conductive film 42a is smaller than the depth of the recess 41.

Then, a photoresist of planar configuration that corresponds to the individual electrode 42 is formed on the conductive film 42a by photolithography. By using the photoresist as a mask, the conductive film 42a is etched and the photoresist is removed thereafter. This creates the individual electrode 42 on the bottom surface of the recess 41 of the glass substrate 4a, as illustrated in FIG. 5(D).

Examples of the method of etching the conductive film 42a include: such physical etching as plasma etching, reactive ion etching, beam etching and light-assisted etching; and such chemical etching as wet etching, one or more of which may be used independently or in combination.

Next, as shown in FIG. 5, drilling operation for the glass substrate 4a is performed with the use of a diamond drill at each of the positions of the glass substrate 4a that correspond to the ink supply hole 43, the sealant introduction hole 44 and the sealant discharge hole 45, respectively, thus creating the holes 43, 44 and 45.

The electrode substrate 4 is produced through the process as set forth hereinabove.

[3] Step of Bonding Substrates

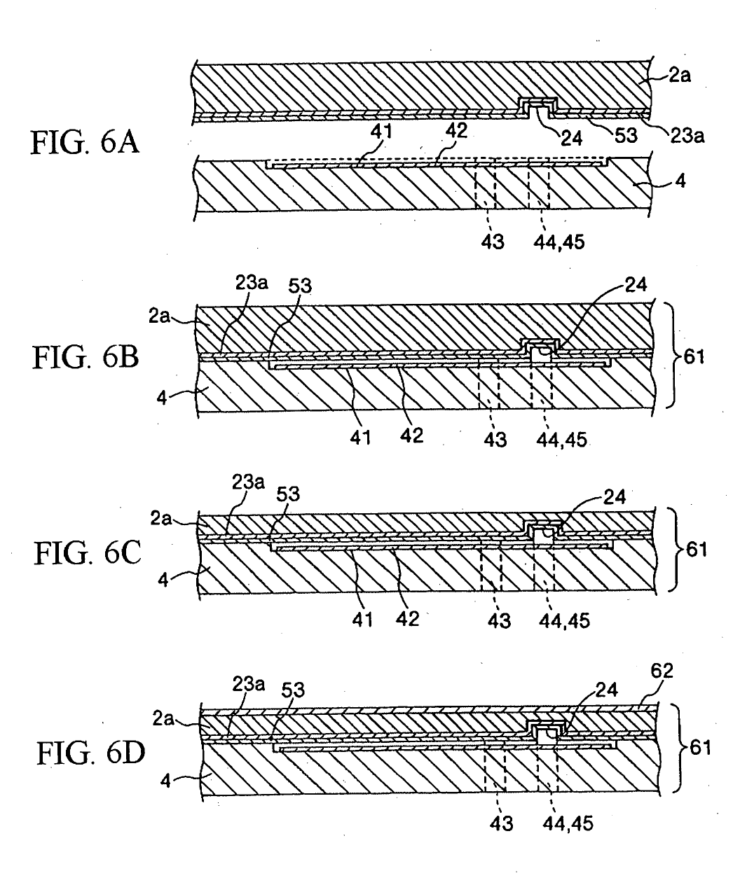

Referring next to FIG. 6(A) and 6(B), the electrode substrate 4 produced above is bonded to the silicon substrate 2a having the sealant introduction hole 24, the impurity diffusion layer 23a and the insulating film 53, by means of anodic bonding and the like, in such a manner that the surface of the electrode substrate 4 on which the individual electrode 42 lies can be faced with the surface of the silicon substrate 2a on which the insulating film 53 is coated, while the sealant introduction hole 44 and the sealant discharge hole 45 are aligned with the opposite ends of the sealant injection groove 24. This results in a bonded substrate 61 in which substrate the sealant injection groove 24, the recess 41, the sealant introduction hole 44 and the sealant discharge hole 45 communicate with each other.

[4] Step of Forming an Ink Ejecting Chamber, a Common Ink Chamber and an Electrode Tail Extension

(4-1) At first, a protective film 7 is attached to the lower surface of the electrode substrate 4 and the upper side of the silicon substrate 2a is cut with the use of, e.g., a grinder, to thereby have the silicon substrate 2a thin-plated. The thickness of the silicon substrate 2a at the end of the cutting operation is preferably 50 to 300 μm and more preferably 100 to 200 μm.

Then the bonded substrate 61 is mounted onto the surface treatment tool such that it can make contact with the surface of the electrode substrate 4 to which the protective film 7 is attached. One example of the surface treatment tool is illustrated in FIG. 12.

The surface treatment tool 20 shown in FIG. 12 is adapted to hold the bonded substrate 61 by vacuum suction and comprises a protecting jig 201 and an O-ring 202.

The protecting jig 201 is provided with a substrate receiving part 203 in the form of a recess whose plane size is somewhat greater than the bonded substrate 61, a plurality of depressions 204 formed on the bottom surface of the substrate receiving part 203, and an O-ring receiving groove 205 formed in the vicinity of the perimeter of the substrate receiving part 203. The O-ring 202 is accommodated in the O-ring receiving groove 205. In the event that the surface treatment tool 20 is used in combination with the protective film 7 as described above, it is important to ensure that the area to which the protective film 7 is attached lies inside of the O-ring 202.

In order to fasten the bonded substrate 61 to the surface treatment tool 20, the bonded substrate 61 is first placed on the substrate receiving part 203 in such a manner that the surface of the electrode substrate 4 to which the protective film 7 is attached can make contact with the substrate receiving part 203. This leaves spaces 206 between the respective depression 204 and the bonded substrate 61. Subsequently, the bonded substrate 61 and the surface treatment tool 20 are transported into a vacuum chamber. After the pressure of the vacuum chamber is reduced gradually, it is then abruptly returned to the atmospheric pressure. At this time, although the exterior of the bonded substrate 61 and the surface treatment tool 20 is under the atmospheric pressure, the pressure within the spaces 206 remains reduced, thereby causing the bonded substrate 61 to be sucked up and fastened to the substrate receiving part 203.

Use of the surface treatment tool 20 described above assures that the lower surface of the electrode substrate 4 is positively protected even from heavily alkaline etching solution to which the protective film 7 is relatively hard to attain chemical resistance.

As shown in FIG. 6(C), under the state that the bonded substrate 61 is attached to the surface treatment tool 20, wet etching is carried out with respect to the entire top surface of the silicon substrate 2a, and then the silicon substrate 2a is thin-plated.

The etching amount is preferably 5 to 30 μm and more preferably 10 to 20 μm.

Examples of the etching solution that can be used in this process include aqueous potassium hydroxide solution, aqueous sodium hydroxide solution and aqueous tetramethylammonium hydroxide (TMAH) solution. In case of using aqueous potassium hydroxide solution, the concentration and the treatment temperature of potassium hydroxide are the same as in the foregoing description.

The thickness of the silicon substrate 2a at the end of the etching process is preferably 50 to 300 μm and more preferably 100 to 200 μm.

At this etching time, the lower surface of the electrode substrate is protected by the protective film and the surface treatment tool, which assures that no etching solution is infiltrated into the ink supply hole 43, the sealant introduction hole 44 and the sealant discharge hole 45.

By virtue of rendering the silicon substrate 2a thin-plated through two process steps, namely, cutting and etching, as described above, it becomes possible to speedily cut away the relatively thick portion of the silicon substrate 2a through the cutting process and, furthermore, to convert the cut surface of the silicon substrate 2a to a relatively smooth and defect-free surface via the etching process. This makes sure that the silicon substrate 2a is thin-plated within a shortened period of time and acquires enhanced surface property.

In the next step, if desired, the silicon substrate 2a is cleansed and then the surface treatment tool 20 is removed. Although there exists no particular limitation in cleansing the silicon substrate 2a, it is preferred that the silicon substrate 2a is cleansed with aqueous ammonia hydrogen peroxide solution, washed by water and then allowed to dry, after which the surface treatment tool 20 is removed and the silicon substrate 2a is re-washed under the condition the protective film 7 is attached thereto. This makes it possible to remove, without fail, any hard-to-clean etching solution such as the etching solution remaining on the surface of the silicon substrate 2a in the vicinity of the O-ring 202.

(4-2) Subsequently, the top surface of the silicon substrate 2a is cleansed with a mixed solution of sulfuric acid and hydrogen peroxide. And then a SiO₂ film 62 is formed on the silicon substrate 2a, as illustrated in FIG. 6(D).

Examples of the method of forming the SiO₂ film 62 include chemical vapor deposition (CVD) such as plasma CVD, thermal CVD and laser CVD and dry plating such as sputtering and the like, but not particularly limited thereto.

Moreover, the thickness of the SiO₂ film 62 is preferably 0.1 to 10 μm, and more preferably 0.5 to 2 μm.

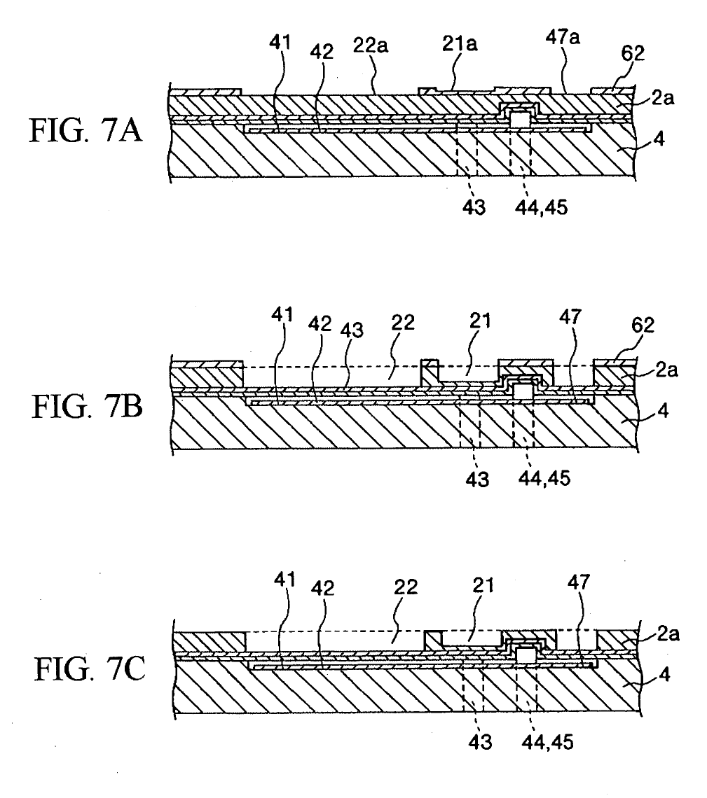

A photoresist is formed on the SiO₂ film 62 by photolithography in such a manner that the photoresist has openings on the parts that correspond to the common ink chamber 21, the ink ejecting chamber 22 and the electrode tail extension 47, respectively. The SiO₂ film 62 is etched by using the photoresist as a mask, at which time the etching is conducted such that, as shown in FIG. 7(A), the SiO₂ film 62 can be completely removed in the area corresponding to the ink ejecting chamber 22 and the electrode tail extension 47, while a part of the SiO₂ film 62 can be left in the area corresponding to the common ink chamber 21. The latter is often referred to as a “half etching”.

Examples of the etching solution usable for this purpose include, but are not particularly limited thereto, aqueous fluoric acid solution, aqueous ammonium fluoride solution and the like.

It is preferred that, if needed, the protective film 7 and the surface treatment tool 20 are used in combination in the process beginning with the cleansing step in which the mixed solution of sulfuric acid and hydrogen peroxide is used and ending with the etching step of the SiO₂ film. This prevents any infiltration, through the holes 43, 44 and 45, of the mixed solution of sulfuric acid and hydrogen peroxide, the agent for developing the photoresist, the water for washing the developing agent, the solution for etching the SiO₂ film 62 and the water for washing the etching solution, throughout the process of conducting the respective step noted above. Additionally, vacuum chucking for the devices used in the respective step, for instance, can be performed in a trustworthy manner, due to the fact that the holes 43, 44 and 45 are kept closed by the protective film 7.

(4-3) In the next step, the protective film 7 is attached to the lower surface of the electrode substrate 4 and the bonded substrate 61 is fastened to the surface treatment tool 20 as illustrated in FIG. 12.

And, as shown in FIG. 7(B), half etching is performed with aqueous potassium hydroxide solution for the parts of the silicon substrate 2a that correspond to the ink ejecting chamber 22 and the electrode tail extension 47.

In this etching process, the concentration and the treatment temperature of the aqueous potassium hydroxide solution are the same as in the foregoing description.

Then, the SiO₂ film 62 left on the part that corresponds to the common ink chamber 21 is removed by use of aqueous fluoric acid solution.

The parts of the silicon substrate 2a that correspond to the common ink chamber 21, the ink ejecting chamber 22 and the electrode tail extension 47 are further etched with the aqueous potassium hydroxide solution until the impurity diffusion layer 23a is exposed at the parts corresponding to the ink ejecting chamber 22 and the electrode tail extension 47. Due to the fact that the etching rate for the aqueous potassium hydroxide solution is smaller at the impurity diffusion layer 23a than at the silicon substrate 2a, it is possible to have the etching process positively ceased just when the impurity diffusion layer 23a is exposed. The etching is terminated under the state that a thin layer of the silicon substrate 2a is left on the impurity diffusion layer 23a. This is because the etching with the aqueous potassium hydroxide solution for the part that corresponds to the common ink chamber 21 is started at a later time than for the parts corresponding to the ink ejecting chamber 22 and the electrode tail extension 47.

At this time, it is important to ensure that the thickness of the residual layer left on the part corresponding to the ink ejecting chamber 22 falls within a appropriate extent, because the residual layer will eventually play the role of the vibrator plate 23. Appropriate thickness of the vibrator plate 23 is 1.0 to 20 μm, although it can vary with the displacement extent of the vibrator plate, the drive voltage and other conditions.

Then, as shown in FIG. 7(D), the SiO₂ film 62 left on the surface of the silicon substrate 2a is removed by use of the aqueous fluoric acid solution.

Subsequently, the bottom part of the part corresponding to the common ink chamber 21 is opened by, e.g., laser cutting, as illustrated in FIG. 8(A) so that the ink supply hole 43 can communicate with the common ink chamber 21.

A cavity substrate 2 is obtained through the process as set forth above.

Examples of the laser that can be used in the laser cutting include a YAG laser, a femto second laser and the like.

Lastly, as shown in FIG. 8(b), a sealant 8 is injected through the sealant introduction hole 44, thus closing the gap between the cavity substrate 2 and the electrode substrate 4.

[5] Step of Bonding a Cavity Substrate and a Nozzle Substrate

As illustrated in FIG. 8(c), the cavity substrate 2 is bonded to the nozzle substrate 3 having an ink orifice 31 and a nozzle hole 32 in such a manner that the nozzle hole 32 can be located around the front end of the ink ejecting chamber 22. This creates the common ink chamber 21, the ink ejecting chamber 22 and the ink orifice 31 in between the cavity substrate 2 and the nozzle substrate 3.

An ink jet head is manufactured by way of dicing the laminated structure of the substrates 2, 3 and 4 obtained through the foregoing process in correspondence to the respective one of head chips.

As described supra, in the method of producing the electrode substrate for the electrostatic actuator, the glass substrate 4a is used as the electrode substrate 4 and the recess 41 in which the individual electrode 42 is disposed is provided by press forming the glass substrate 4a. In other words, no etching is performed to form the recess for accommodating the individual electrode. This makes it possible to avoid widening of pattern and creating of ripple-shaped irregularities which would otherwise be generated at the time of employing a gray scale.

Further, use of the press forming method assures that the depression-and-protrusion pattern of the pressing mold is precisely transferred to the glass substrate, thereby making sure that the recess of minute configuration can be formed with an increased degree of precision even in the case the recess is bitterly miniaturized in concert with the high density fabrication of the electrostatic actuator.

In addition to the above, the press forming method allows the one and same pressing mold to be used repeatedly, thus making it possible to produce the electrode substrate with excellent reproducibility and in a cost-effective manner.

Accordingly, incorporation of the electrode substrate produced in this way into the ink jet head, for instance, assists in improving the ink ejecting property, densely arranging the nozzle holes and reducing the manufacturing cost of the ink jet head.

### Second Embodiment

A second embodiment of the present invention is described in the following. The description on the second embodiment will be centered on the parts that differ from the first embodiment and no description will be made regarding the same parts as in the first embodiment.

At first, an ink jet head is described which comprises the electrode substrate obtained by the method of producing the electrode substrate according to the second embodiment.

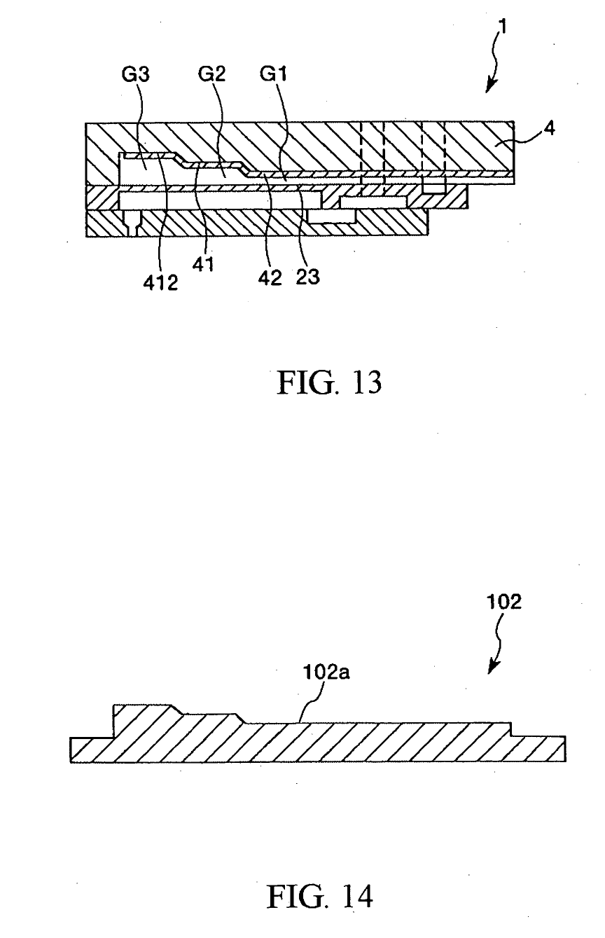

FIG. 13 is a cross-sectional view showing the ink jet head in accordance with the second embodiment. It should be understood that “top” or “upper” in the following description means the upward direction or the top area, “bottom” or “lower” denotes the downward direction or the bottom area, “front” or “frontward” indicates the left side, and “rear” or “rearward” means the right side, as viewed in FIG. 13.

The ink jet head 1 shown in FIG. 13 is the same as the ink jet head of the first embodiment except for the shape of each of the recesses 41 formed on the electrode substrate 4.

In this ink jet head 1, the electrode substrate 4 is provided with a plurality of recesses 41 on the surface that is to be bonded to the cavity substrate 2 and at such positions that correspond to the respective vibrator plates 23.

According to the second embodiment, the bottom surface 412 of each recess 41 of the electrode substrate 4 is of step-like configuration so that there can be provided a number of gaps G1, G2 and G3 whose size becomes greater stepwise from the rear side to the front side between the vibrator plate 23 and the individual electrode 42. In other words, each recess 41 has a portion whose depth is gradually reduced in a stepwise manner from one end to the other in a longitudinal direction of the recess 41.

As the drive voltage is applied in the ink jet head 1, the part of the vibrator plate 23 corresponding to the gap G1, the part corresponding to the gap G2 and the part corresponding to the gap G3 are pulled one after another toward the individual electrode 42 in this sequence. If the parts of the vibrator plate 23 are pulled stepwise toward the individual electrode 42 in this manner, weak undulatory motion of ink pressure takes place such that small ink droplets can be ejected in a mutually disconnected manner (in the forms of a number of droplets). This makes it possible to generate a sufficient level of ink ejecting force, while reducing the drive voltage needed, as a result of which excellent ink ejecting property can be obtained.

A method of manufacturing the ink jet head that incorporates the electrode substrate production method in accordance with the second embodiment will now be described based on the example wherein the ink jet head shown in FIG. 13 is fabricated.

FIG. 14 is a cross-sectional view illustrating a pressing mold employed in the second embodiment.

The method of manufacturing the ink jet head in this embodiment is the same as the method of the first embodiment, except that a pressing mold which is different from the pressing mold shown in FIG. 11 is employed in the step corresponding to step [2] of the first embodiment.

Specifically, as illustrated in FIG. 14, the pressing mold 102 used in this manufacturing method is provided with a depression-and-protrusion 102a formed as an inverse pattern of the depression-and-protrusion pattern that corresponds to each step-like recess 41 created on the electrode substrate 4 of the ink jet head 1 shown in FIG. 13. The electrode substrate 4 is produced by way of press forming the glass substrate 4a using this pressing mold 102 mounted on the press forming apparatus 10.

The same operation and beneficial effects as in the first embodiment are attained in accordance with the second embodiment.

The electrode substrate produced according to the second embodiment also has a plurality of recesses in which a bottom surface of each recess is of step-like configuration. Therefore, incorporation of this type of electrode substrate into the ink jet head, for instance, provides excellent ink ejecting property.

### Third Embodiment

A third embodiment of the present invention will be described in the following. The description on the third embodiment will be focused on the parts that differ from the first embodiment and no description will be made with regard to the same parts as in the first embodiment.

At first, an ink jet head will be described which incorporates the electrode substrate obtained by the method of producing the electrode substrate according to the third embodiment.

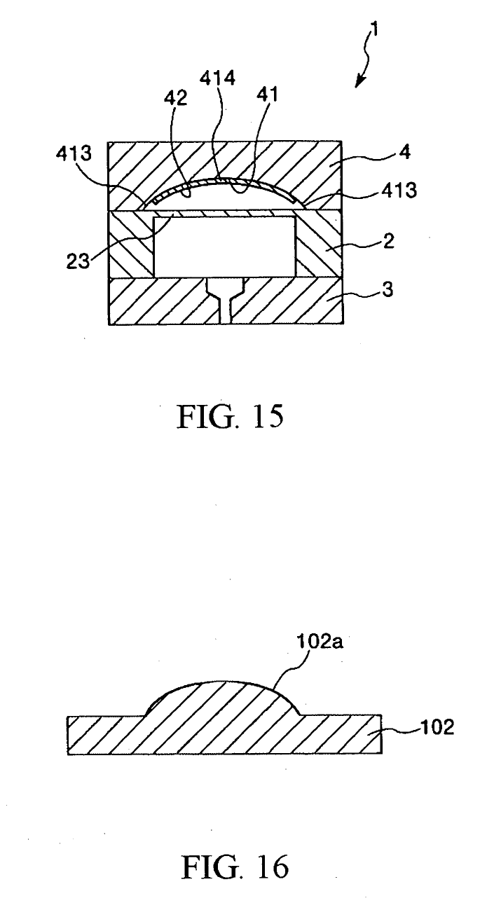

FIG. 15 is a cross-sectional view showing the ink jet head obtained in accordance with the third embodiment. It should be understood that “top” or “upper” in the following description indicates the upward direction or the top area, “bottom” or “lower” indicates the downward direction or the bottom area, “front” or “frontward” indicates the left side, and “rear” or “rearward” indicates the right side, as viewed in FIG. 15.

The ink jet head 1 shown in FIG. 15 is the same as the ink jet head of the first embodiment except for the shape of each recess 41 formed on the electrode substrate 4.

In more details, in this ink jet head 1, the electrode substrate 4 is provided with a plurality of recesses 41 on the surface that is to be bonded to the cavity substrate 2 and at such positions that correspond to the respective vibrator plates 23.

According to the third embodiment, the bottom surface of each recess 41 has a curved configuration such that the gap between the vibrator plate 23 and the individual electrode 42 can be gradually decreased from the center to the opposite ends in the transverse direction of the recess 41, which is perpendicular to the longitudinal direction of the vibrator plate 23. In other words, each recess 41 has a part of different depth and the depth is gradually reduced from the center to the opposite ends in the transverse direction perpendicular to the longitudinal direction of the recess 41.

In this ink jet head 1, the opposite ends of the vibrator plate 23 are caused to displace by the drive voltage of a relatively low level. Such displacement of the opposite ends of the vibrator plate 23 acts to reduce the gap between the central part of the vibrator plate 23 and the individual electrode 42, which means that the central part of the vibrator plate 23 can be displaced with relatively low drive voltage. In this way, it becomes possible to drive the vibrator plate 23 as a whole with the use of low voltage, by allowing the gap between the vibrator plate 23 and the individual electrode 42 to be gradually decreased from the center to the opposite ends.

A method of manufacturing the ink jet head that incorporates the electrode substrate production method in accordance with the third embodiment will now be described based on the example wherein the ink jet head shown in FIG. 15 is to be manufactured.

FIG. 16 is a cross-sectional view illustrating a pressing mold employed in the third embodiment.

The method of manufacturing the ink jet head in this embodiment is the same as the method of the first embodiment, except that a pressing mold different from the pressing mold shown in FIG. 11 is employed in the step corresponding to step [2] of the first embodiment.

Specifically, as illustrated in FIG. 16, the pressing mold 102 used in this manufacturing method is provided with a depression-and-protrusion 102a formed as an inverse pattern of the depression-and-protrusion pattern that corresponds to the curved recess 41 created on the electrode substrate 4 of the ink jet head 1 shown in FIG. 15. The electrode substrate 4 is produced by way of press forming the glass substrate 4a using this pressing mold 102 mounted on the press forming apparatus 10.

The same operation and beneficial effects as in the first embodiment are attained in accordance with the third embodiment.

The electrode substrate produced according to the third embodiment also has a plurality of recesses, in which a bottom surface of each recess is of curved configuration. According to the ink jet head provided with this type of electrode substrate, it is possible to drive the vibrator plate with reduced voltage.

### Fourth Embodiment

A fourth embodiment of the present invention will be described in the following. The description on the fourth embodiment will be focused on the parts that differ from the first embodiment and no description will be made with regard to the same parts as in the first embodiment.

At first, an ink jet head will be described which is provided with the electrode substrate obtained by the method of producing the electrode substrate according to the fourth embodiment.

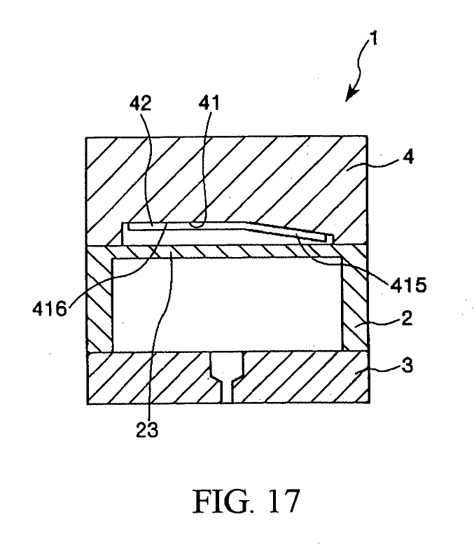

FIG. 17 is a cross-sectional view showing the ink jet head in accordance with the fourth embodiment. It should be understood that “top” or “upper” in the following description indicates the upward direction or the top area, “bottom” or “lower” indicates the downward direction or the bottom area, “front” or “frontward” indicates the left side, and “rear” or “rearward” indicates the right side, as viewed in FIG. 17.

The ink jet head 1 shown in FIG. 17 is the same as the ink jet head of the first embodiment except for the shape of each of the recesses 41 formed on the electrode substrate 4.

In more details, with this ink jet head 1, the electrode substrate 4 is provided with a plurality of recesses 41 on the surface that is to be bonded to the cavity substrate 2 and at such positions that correspond to the respective vibrator plates 23.

According to the third embodiment, the bottom surface of each recess 41 has a slant surface 415 and a planar surface 416 such that the gap between the vibrator plate 23 and the individual electrode 42 can be gradually increased from one end to the center but remain uniform from the center to the other end in the transverse direction of the recess 41, which is perpendicular to the longitudinal direction of the vibrator plate 23. In other words, the recess 41 has a part of different depth and the depth in a transverse partial area (the slant surface 415) of the recess is gradually and continuously reduced from one end to the other.

In this ink jet head 1, the same beneficial effects can be obtained as with the ink jet head 1 of the second and third embodiments described above. In other words, as the drive voltage is applied, the part of the vibrator plate 23 corresponding to the slant surface 415 of the recess 41 and the part corresponding to the planar surface 416 of the recess 41 are pulled one after another toward the individual electrode 42 in this sequence. Excellent ink ejecting property can be obtained by way of causing the parts of the vibrator plate 23 to be pulled stepwise toward the individual electrode 42 in this manner. Moreover, one end of the vibrator plate 23 can be caused to displace with the use of relatively low drive voltage, which in turn reduces the gap of the other end of the vibrator plate 23. In this way, it becomes possible to drive the vibrator plate 23 as a whole with the use of reduced voltage.

A method of manufacturing the ink jet head that incorporates the electrode substrate production method in accordance with the fourth embodiment will now be described based on the example wherein the ink jet head shown in FIG. 17 is to be manufactured.

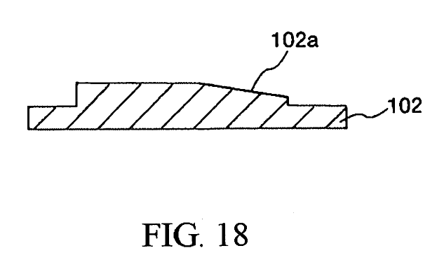

FIG. 18 is a cross-sectional view illustrating a pressing mold employed in the fourth embodiment.

The method of manufacturing the ink jet head in this embodiment is the same as the method of the first embodiment, except that a pressing mold different from the pressing mold shown in FIG. 11 is employed in the step corresponding to step [2] of the first embodiment.

Specifically, as illustrated in FIG. 18, the pressing mold 102 used in this manufacturing method is provided with a depression-and-protrusion 102a formed as an inverse pattern of the depression-and-protrusion pattern that corresponds to each recess 41 having the slant surface 415 and the planar surface 416 created on the electrode substrate of the ink jet head shown in FIG. 17. The electrode substrate 4 is produced by way of press forming the glass substrate 4a using this pressing mold 102 mounted on the press forming apparatus 10.

The same operation and beneficial effects as in the first embodiment are obtained in accordance with the fourth embodiment.

The electrode substrate produced according to the fourth embodiment has a plurality of recesses 41, in which a bottom surface of each recess 41 has the slant surface and the planar surface. Therefore, according to the ink jet head provided with this type of electrode substrate into the ink jet head, it is possible to provide excellent ink ejecting property and to drive the vibrator plate with reduced voltage.

Although the method of producing an electrode substrate according to the present invention has been described based on the particular embodiments described above for illustrative purposes, the present invention is not limited to these embodiments.

For instance, the method of producing an electrode substrate according to the present invention may further comprise one or more optional step, if needed, in addition to the steps described above.

It should also be appreciated that the electrostatic actuator incorporating the electrode substrate produced in accordance with the present invention may be employed in other liquid droplet ejecting apparatus than the ink jet printer. Examples of such other use include production of protein chips or DNA chips, preparation of color filters in organic EL element manufacturing devices or liquid crystal display, fabrication of wiring substrates by ink jet method and the like. In these cases, an electrostatic actuator having a single ink ejecting chamber formed of a vibrator plate and an electrode provided in a recess may be used. It is needless to say that the electrostatic actuator of the present invention can be used in other liquid droplet ejecting apparatuses such as photo scanners.

Finally, it should be noted that the subject application is based on Japanese Patent Application No. 2004-174684 filed on Jun. 11, 2004, the entire disclosure of which is incorporated herein by reference.

1. A method of producing an electrode substrate, comprising:
a first step of forming at least one recess on a substrate mainly composed of glass through a press forming process in which a pressing mold is pressed against the substrate; and
a second step of providing an electrode on a bottom surface of the recess.

2. The method of producing an electrode substrate as claimed in claim 1, wherein the press forming process is carried out under a condition that the substrate is heated up to a temperature of 350 to 800° C.

3. The method of producing an electrode substrate as claimed in claim 1, wherein the glass has a coefficient of thermal expansion in the range of 20×10⁻⁷ to 90×10⁻⁷° C.⁻¹.

4. The method of producing an electrode substrate as claimed in claim 3, wherein the glass is mainly composed of borosilicate glass.

5. The method of producing an electrode substrate as claimed in claim 1, wherein the pressing mold is mainly composed of quartz.

6. The method of producing an electrode substrate as claimed in claim 1, wherein the pressing mold is subjected to mold release treatment at least on a pressure-applying contact surface of the pressing mold that makes contact with the substrate.

7. The method of producing an electrode substrate as claimed in claim 6, wherein the mold release treatment is carried out by applying an release agent to the pressure-applying contact surface.

8. The method of producing an electrode substrate as claimed in claim 6, wherein the mold release treatment is carried out by forming a film on the pressure-applying contact surface, the film mainly composed of a material selected from the group consisting of platinum-containing alloy and iridium-containing alloy.

9. The method of producing an electrode substrate as claimed in claim 8, wherein the film is formed on the pressure-applying contact surface under a condition that a base layer for assuring close contact of the film with the pressing mold is disposed between the film and the pressure-applying contact surface.

10. The method of producing an electrode substrate as claimed claim 9, wherein the base layer is mainly composed of nickel.

11. The method of producing an electrode substrate as claimed in claim 8, wherein the film is formed after the pressure-applying contact surface is subjected to a surface roughening process.

12. The method of producing an electrode substrate as claimed in claim 11, wherein the surface roughening process includes reverse sputtering.

13. The method of producing an electrode substrate as claimed in claim 1, wherein the recess is provided with portions of different depth.

14. The method of producing an electrode substrate as claimed in claim 13, wherein the recess extends substantially linearly and has at least a portion whose depth is gradually reduced in a continuous or stepwise manner from one side to the other in a longitudinal direction of the recess.

15. The method of producing an electrode substrate as claimed in claim 13, wherein the recess extends substantially linearly and has a depth gradually reducing from a center to opposite ends in a transverse direction perpendicular to a longitudinal direction of the recess.

16. An electrode substrate produced according to the method as claimed in claim 1.

17. An electrode substrate, comprising:
a substrate mainly composed of glass and having at least one recess formed through a press forming process in which a pressing mold is pressed against the substrate; and
an electrode provided on a bottom surface of the recess of the substrate.

18. The electrode substrate as claimed in claim 17, wherein the electrode is formed substantially simultaneously with the recess by press forming a constituent material for the substrate under a condition that a constituent material for the electrode is disposed between the constituent material of the substrate and the pressing mold.

19. An electrostatic actuator, comprising:
an electrode substrate as recited in claim 16; and
a vibrator plate adapted to face an electrode of the electrode substrate with a minute gap between the vibrator and the electrode,
wherein the vibrator plate is displaceable by an electrostatic force induced when electric voltage is applied between the electrode and the vibrator plate.

20. A liquid droplet ejecting head equipped with the electrostatic actuator as recited in claim 19.

21. A liquid droplet ejecting apparatus equipped with the liquid droplet ejecting head as recited in claim 20.
